(19) United States
(12) Patent Application Publication
(10) Pub. No.: US 2011/0180278 A1
(43) Pub. Date: Jul. 28, 2011

(54) Fire containment devices and components therefor

(75) Inventors: Brett Stuart Magnay, Wooloowin (AU); Richard Augustine Cooke, Thornlands (AU)

(73) Assignee: IG6 Pty. Ltd.

(21) Appl. No.: 12/927,367

(22) Filed: Nov. 12, 2010

(30) Foreign Application Priority Data
Dec. 10, 2008 (AU) 2008906418
Apr. 23, 2009 (AU) 2009901768

(51) Int. Cl. A62C 2/06

(52) U.S. Cl. 169/48

(57) ABSTRACT

A fire containment device including:

heat reactive blocking means having at least two layers of intumescent material with one or more layers of fabric between at least two of said at least two layers of intumescent material.

### TECHNICAL FIELD OF THE INVENTION

This invention relates to fire containment devices such as fire dampers, fire collars, fire wraps, fire rated expansion strips, fire rated joining strips, and components therefor.

### BACKGROUND

Various fire containment devices are used for preventing fire spreading from one side of a wall or floor (particularly in high ride buildings) to the other side, some examples being fire collars, fire dampers or fire wraps for pipes, ducts and other service carriers which pass through penetrations in the wall or floor. Other examples are fire rated expansion strips in or around doors and fire rated joints for forming seals between walls and ceilings or between adjacent wall panels or the like etc. Such devices are typically required to prevent the passage of smoke and gases arising from a fire on one side of a wall or floor to the other side as well as preventing the spread of fire for a period of time, for example, as set by the relevant regulatory authorities.

The presently available fire containment devices typically incorporate a heat reactive material such as a layer of intumescent material which is adapted to expand upon the ambient, temperature reaching a predetermined level so as to close off the penetration in a floor or wall or the gap between adjacent walls or ceilings etc as the case may be.

Fire collars typically include a housing in which a layer of intumescent material is mounted, commonly in the form of an annular cylinder through which the conduit passes so that the intumescent material extends around the conduit, with the housing providing a bearing face adapted to withstand the forces of the intumescent material as it expands during a fire situation. Fire wraps are typically used in similar circumstances as fire collars but without such a housing being required, the wrap being typically fitted in an annular space between the conduit and the wall or floor through which it passes with the wall or floor providing the required bearing face. However, as the conduit softens or burns during a fire, the volume of space to be taken up by the expanding intumescent material increases and in some cases some of the intumescent material can fall out of its proper place and thus reduce the fire rating of the device.

Fire rated expansion strips or joining strips typically rely on the opposite faces of the door and the door jamb or the ceiling and the wall top plate to provide suitable bearing faces but commonly nothing is provided at the open edges to contain the intumescent material and consequently, in a similar manner to the collars and wraps previously mentioned, some of the intumescent material can fall out and thereby reduce the fire rating of the strip or the wall or door to which it is fitted.

The forces which the aforementioned containment devices can develop in fire situations are not as high as desired and consequently they do not achieve as high a fire rating as desired or cannot be used at all in some situations because they do not have the capacity to close a penetration or opening. For example, many fire collars are effective with low pressure pipes and ducts formed wholly or almost wholly from plastics materials, for example, PVC and HDPE, but they are not suitable for use with gas pipes having a layer of aluminium sandwiched between two layers of plastics material and similar multi-layered pipes or with heavier walled plastic pipes and high pressure plastic pipes made of plastics or plastics and metals.

The present invention is aimed at providing fire containment devices which are capable of improved fire ratings or at least are reliable and efficient in use.

### SUMMARY OF THE INVENTION

With the foregoing in view, the present invention resides broadly in a fire containment device including:

heat reactive blocking means having at least two layers of intumescent material with one or more layers of fabric between at least two of said at least two layers of intumescent material.

Preferably, at least one of said one or more layers of fabric is a layer of metal fabric for example, stainless steel gauze. Such gauze may be woven, pressed, bonded or otherwise suitably formed. However, other fabrics such as glass or ceramic gauze may be used if desired although perhaps to lesser advantage. Advantageously, it has been found that the fabric holds the intumescent material in place for a longer period in a fire situation than without the fabric as the intumescent material expands under heating thereby ensuring that a greater volume of intumescent material is available to fill the space, void or penetration required to be closed. It is believed that the fabric enhances the ability of the cohesive forces to hold the intumescent material together. Advantageously, retention of a greater volume of intumescent material within a containment device results in the intumescent material applying a greater pressure to the conduit, door jamb or the like with the result that wraps and fire collars can be used to close off thicker walled PVC plastic pipes and even multilayered pipes (including a layer of aluminium) as they soften over a longer period than a low pressure thin walled PVC plastic pipe. It is also believed that the fabric provides a bearing surface against which at least some of the expanding intumescent material may bear and thereby achieves better sealing.

In a preferred form of the invention, the layer of fabric extends fully between the layers of intumescent material but in another form, the layer of fabric extends only between the adjacent longitudinal edge portions of the two layers of intumescent material. In still another form, the layer of fabric is constituted by spaced apart segments of fabric. In one such form, the segments are selected and arranged such that they meet upon the heat reactive blocking means being wrapped about a selected conduit or fitted within a selected penetration or within a selected housing.

In another aspect, the invention resides broadly in a fire collar including:

a mounting having an opening adapted to receive a conduit therethrough; and

heat reactive blocking means supported by said mounting adjacent said opening, said heat reactive blocking means defining a passage aligned with said opening and adapted to receive a conduit therethrough, said heat reactive blocking means including at least two layers of intumescent material with a layer of fabric therebetween.

Preferably, said mounting includes a housing having a passage therethrough and opening at opposite ends with said heat reactive blocking means being housed within said housing and being adapted to at least partially form a sleeve about a conduit passing through said passage.

In another aspect the invention resides broadly in a fire collar adapted to be set into a concrete barrier during formation of the barrier, including:

a housing;

heat reactive blocking means in said housing including at least two layers of intumescent material with a layer of fabric between at least two of said at least two layers of intumescent material and defining a passage adapted to receive a conduit therethrough, said housing being adapted to protect said heat reactive blocking means and maintain said passage during formation of a concrete barrier about said housing.

In yet another aspect, the invention resides broadly in a heat reactive material including one or more layers of fabric substantially encased in an intumescent material.

In yet another aspect, the invention resides broadly in a heat reactive material including an intumescent material having one or more layers of fabric therein engaged with said intumescent material.

In still yet another aspect, the invention resides broadly in a heat reactive material including an intumescent material having a fabric therein adapted in use to enhance the ability of the cohesive forces in the intumescent material to generally hold the intumescent material in a predetermined space.

The terms “upper”, “lower”, “side” and similar terms are used herein for the purposes of describing the invention in its normal in use position, particularly in relation to devices which are installed in a building floor or wall, unless the context clearly indicates another meaning and such terms are not intended to limit the invention to use in any particular orientation. Additionally, it is to be understood that the invention could be used in floors, walls, ceilings and other barriers of various types and orientations. It is also to be understood that the term “longitudinal” used herein refers to the axial direction of a conduit as it passes through a fire collar, wrap or other fire containment device according to the invention unless the context clearly indicates another meaning.

### BRIEF DESCRIPTION OF THE DRAWINGS

In order that the invention may be more easily understood and put into practical effect, reference will now be made to the accompanying drawings wherein:

FIG. 1 is a perspective view of a fire collar according to the invention from the bottom end with the torsion spring in a loaded (or non-operating) position;

FIG. 2 is a perspective view of the fire collar of FIG. 1 from the top end (with the top cap removed) also with the torsion spring in the loaded position;

FIG. 3 is a perspective view of the fire collar of FIG. 1 from one side also with the torsion spring in the loaded position;

FIG. 4 is a sectional elevation of a portion of the fire collar of FIG. 1 along a diametral plane showing the torsion spring in the loaded position;

FIG. 5 is a sectional end view of the heat reactive tube of the fire collar of FIG. 1, that is, from the top end;

FIG. 6 is a sectional elevation of a sheet of heat reactive material for making the heat reactive tube of the fire collar of FIG. 1 or for use in other types of fire containment devices;

FIG. 7 is a sectional end view of another heat reactive tube suitable for use as an alternative in the fire collar of FIG. 1;

FIG. 8 is a sectional end view of another heat reactive tube suitable for use in the fire collar of FIG. 1;

FIG. 9 is a plan of a blank of an alternative fabric for use between layers of intumescent material in any of the previously mentioned heat reactive tubes;

FIG. 10 is a plan of a retrofit fire collar according to the invention from the bottom end prior to use with hidden detail omitted;

FIG. 11 is a sectional elevation of the fire collar of FIG. 10 along line 11-11 (a diametral plane) prior to expansion of the heat reactive material;

FIG. 12 is a plan of the fire collar of FIG. 10 from the bottom end after use with hidden detail omitted; and

FIG. 13 is a sectional end view of the fire collar of FIG. 10 after use.

### DETAILED DESCRIPTION OF THE DRAWINGS

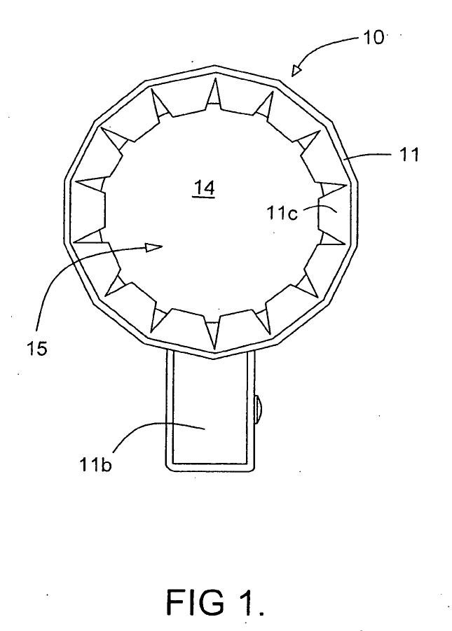

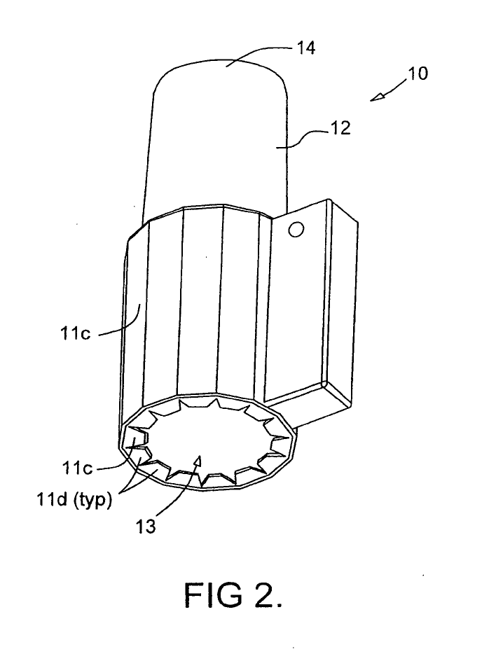

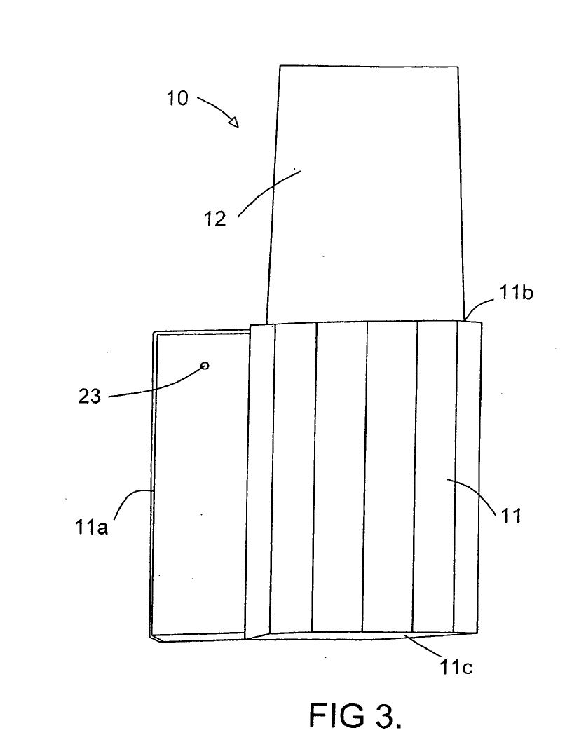

The fire collar 10 illustrated in FIGS. 1 to 3 includes a main housing 11 constructed of a galvanized steel sheet with a housing extension 12 formed of plastics material extending upwardly therefrom. The housing 11 has a substantially cylindrical side wall 11a which terminates at its opposite ends in respective spaced apart top and bottom end flanges 11b and 11c comprising a plurality of angularly spaced segments 11d. The flanges define respective central openings 13 and 14 to the housing which is adapted to receive therethrough a typical 60 mm layered gas pipe of the type having an aluminium tube sandwiched between two concentric layers of a plastics material so as to form a three layered pipe wall. The bottom flange is adapted to rest against a sheet of formwork and be secured thereto so that a concrete wall or floor can be poured around the housing while the housing extension (shown with the top wall removed) prevents the ingress of concrete into the housing during pouring.

One elongate generally rectangular opening 16 is provided in the side wall of the housing and two spaced apart walls 17 and 18 extend substantially radially outwardly therefrom where they are joined by a planar outer wall 19 generally concentric with the side wall 12 or parallel to a tangent to the side wall to define a recess 21. The walls 17 in this case are parallel to a plane containing the longitudinal axis of the housing but ion other forms they could converge or diverge if desired. The recess houses therein a torsion spring 22 which is retained by a pin 23 extending through the recess and is secured in the spaced apart radial walls on the spring axis 24. The opposed tails 26 and 27 of the spring are held together in the loaded position by a fusible link 28 as can be seen in FIG. 1.

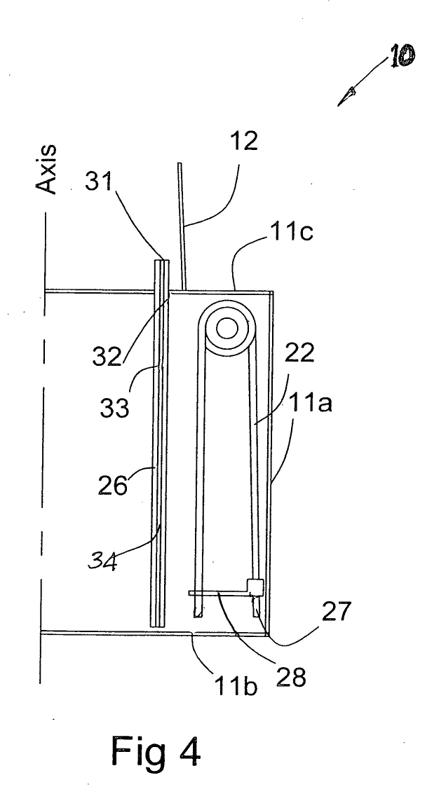

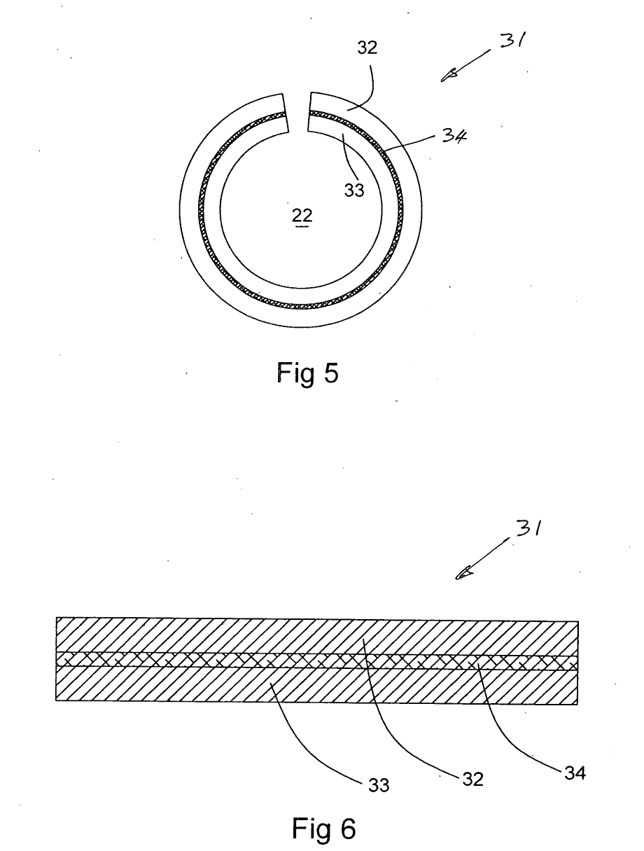

A heat responsive blocking tube 31 comprising two layers of heat reactive intumescent material 32 and 33 (typically neoprene based or high density polypropylene) having therebetween a layer of stainless steel gauze 34 as can be more clearly seen in FIG. 4 is fitted within the housing adjacent the inner face of the cylindrical wall 11a to form a passage 36 and is retained in the housing by the top and bottom flanges. Typically, each layer of intumescent material is about 3 mm to 5 mm thick. The tube has been rolled from the sheet 30 illustrated in FIG. 6. In the case of collars for use with larger diameter pipes, the layers of intumescent material may be thicker but preferably, more layers of the same thickness are used with a layer of gauze between adjacent layers of intumescent material.

The fire collar 110 illustrated in FIG. 10 is the same as the collar illustrated in FIG. 1 in many respects and consequently, corresponding reference numbers are used to reference corresponding components where suitable. The fire collar 110 includes a housing 111 constructed of galvanized steel sheet with a substantially cylindrical side wall 111a which terminates at its opposite ends in respective spaced apart top and bottom end segmented flanges 111b and 111c which define respective central openings 113 and 114 adapted to receive therethrough a typical 60 mm layered gas pipe of the type having an aluminium tube sandwiched between two concentric plastic tubes.

The top flange is adapted to rest against the bottom face of a concrete floor or the side face of a concrete wall adjacent a penetration with a PVC plumbing pipe of a layered PVC and aluminium gas pipe therethrough. Suitably, the housing has mounting lugs (not shown) extending outwards from the side wall for securing the fire collar to the floor or wall as the case may be by screws or bolts. In other embodiments, the collar includes a plastic forming extension to provide for fitting the collar in a floor during construction.

A heat reactive expansion tube 131 comprising two layers of heat reactive intumescent material 132 and 133 with a layer of stainless steel gauze 134 therebetween in the same form as tube 31 is fitted within the housing in the same manner as in FIG. 1 and is retained in the housing by the top and bottom flanges. It will be appreciated that the fire collar 110 does not include any springs or similar devices for assisting the heat reactive material in forcing the gas pipe to collapse and close.

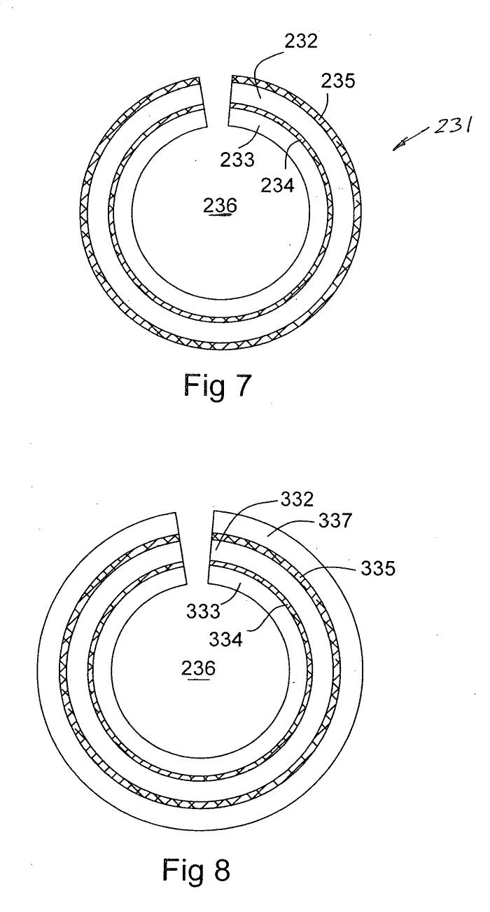

In other fire collars, alternative heat reactive tubes 231 and 331 as shown in FIGS. 7 and 8 may be used instead of tubes 31 or 131, especially for larger pipes depending on the application and the type of pipe involved. Heat reactive blocking tube 231 has a layer of stainless steel gauze 234 between two layers of intumescent material 232 and 233 as in tube 131 but in this form, an extra layer of gauze 235 is provided outside the outermost layer of intumescent material. Heat reactive blocking tube 331 is similar to the previously described tubes but has three layers of intumescent material 332, 333 and 337 with layers of gauze 334 and 335 between adjacent layers of intumescent material.

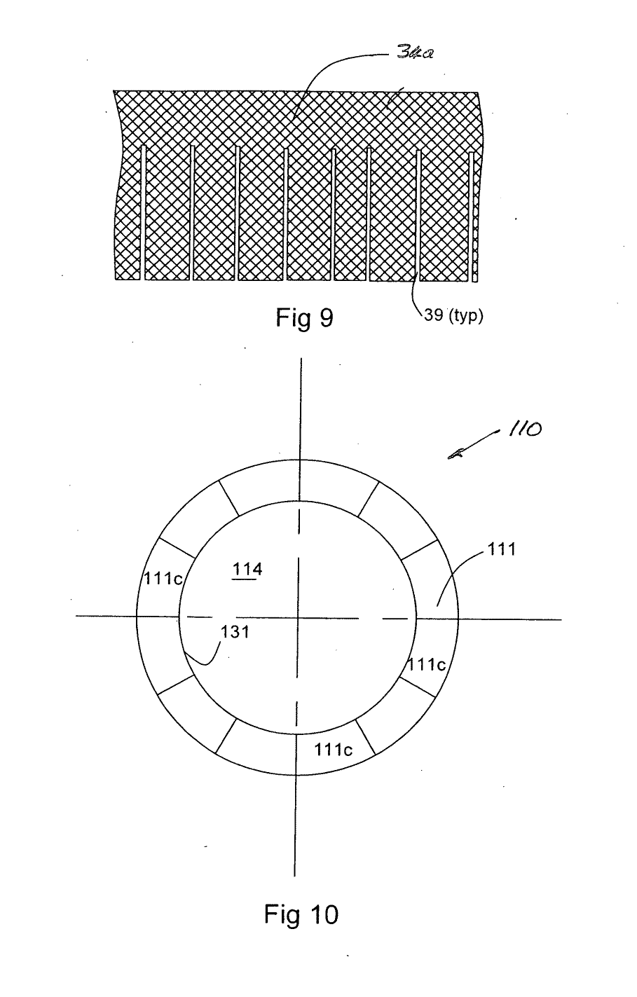

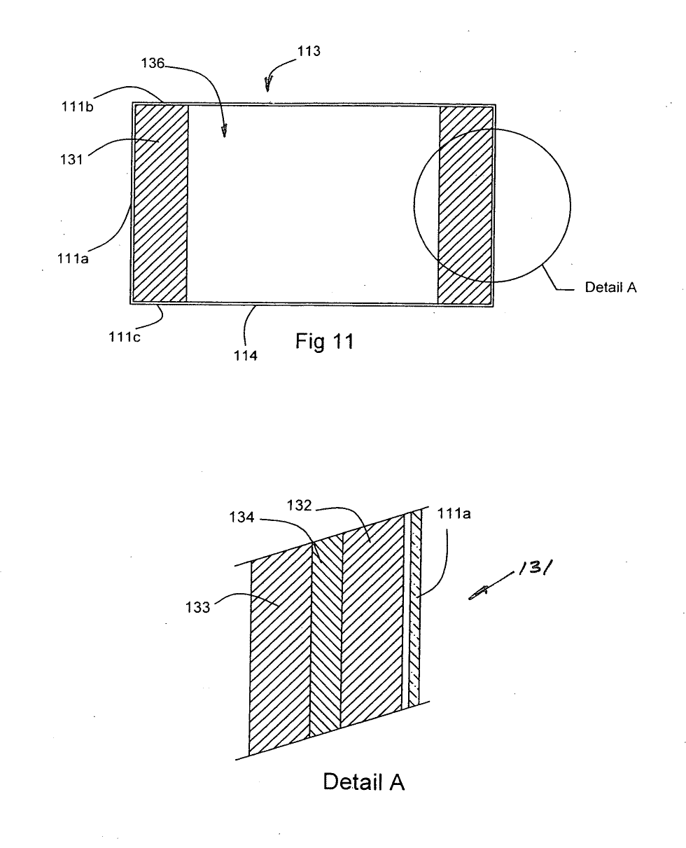

In the aforementioned heat reactive blocking tubes, each layer of gauze is cut to form a right cylinder but if desired, slits such as slits 39 as illustrated in FIG. 9 may be formed in the gauze, the slits running in the axial direction of the fire collar housing to which the tube is to be fitted and being aimed at allowing a predetermined amount of flexing between the layers of intumescent material and the gauze. In particular such slits may be provided in proximity to the intended line of contact of the spring tail with the tube so as to allow the spring tail to work more easily against the pipe around which the fire collar is mounted.

In some embodiments, the heat reactive material from which the tubes are formed is moulded with the intumescent material and gauze forming an integrated unit either as a tube or as a sheet from which the tubes can be cut and formed.

It will be appreciated that the sheet of heat reactive material 30 illustrated in FIG. 6 can be cut to form a “fire containment wrap” or as a component of such devices for use around pipes passing through floor or wall penetrations. The product can also be used in fire rated expansion joints or strips and jointing strips. In one such form, the heat reactive material may be manufactured in flat elongate strips of generally rectangular cross section while in other forms it may have a different shaped cross section. One particularly useful product of circular cross section has a central core of intumescent material with a layer of stainless steel gauze thereabout and then an annular layer of intumescent material about the gauze. On course, a plurality of layers of gauze may be sandwiches between concentric or eccentric layers of intumescent material.

In use, in the event of a fire in sufficient proximity to the fire collar illustrated in FIG. 1, the ambient air increases in temperature and causes the fusible link 28 to soften and break under the spring force of the torsion spring 22 (or alternatively it melts)where upon the spring is released and the outer tail 27 bears against the outer wall 19 of the spring housing and the inner tail 26 bears against the outer face of the heat reactive tube thereby forcing the tube inwards towards the axis of the layered pipe about which the fire collar is mounted with the pipe passing through the openings 13 and 14, that is, through the passage 36. It will be appreciated that the outer layer of PVC of the layered pipe passing through the passage will have softened coincidentally and may have even burned to an extent allowing the torsion spring tail 26 to act on the layer of aluminium in the layered pipe whereby a small collapse on one side is believed to enhance the crushing ability of the intumescent material. Advantageously, the stainless steel gauze holds the layers of intumescent material together sufficiently to allow the expanding intumescent material with the help of the spring to close the pipe without crumbling whilst waiting for the pipe to soften.

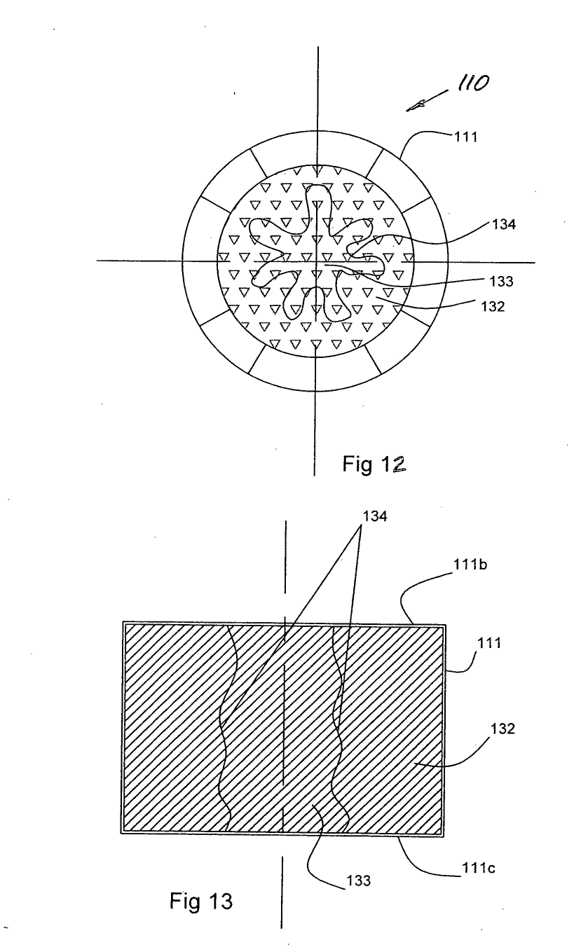

The fire collar 110 illustrated in FIG. 12 operates in much the same manner as that of FIG. 1 in the event of fire except that there is no spring assistance. As can be seen in FIGS. 12 and 13, in the intumescent material expands in response to increasing heat and the expanding intumescent material causes the layer of gauze to move inwards and take up a multi-pointed star or flower shape (in cross-sectional plan). It is believed that the gauze enhances the cohesive forces of the particles of intumescent material so as to inhibit break-up of the intumescent material thereby lessening fall-out during and after expansion.

The foregoing description has been given by way of illustrative example of the invention and many modifications in variations which will be apparent to persons skilled in the art may be made without departing from the spirit and scope of the invention as defined by the appended claims.

We Claim:

1. A fire containment device including:
heat reactive blocking means having at least two layers of intumescent material with one or more layers of fabric between at least two of said at least two layers of intumescent material.

2. A fire containment device according to claim 1, wherein the layer of fabric extends fully between the layers of intumescent material.

3. A fire containment device according to claim 1, wherein the layer of fabric extends only between the adjacent longitudinal edge portions of the two layers of intumescent material.

4. A fire containment device according to claim 1, wherein the layer of fabric is constituted by spaced apart segments of fabric.

5. A fire containment device according to claim 1 wherein at least one of said one or more layers of fabric is a layer of metal fabric.

6. A fire containment device according to claim 5, wherein said metal fabric is stainless steel gauze.

7. A fire collar including:
a mounting having an opening adapted to receive .a conduit therethrough; and
heat reactive blocking means supported by said mounting adjacent said opening, said heat reactive blocking means defining a passage aligned with said opening and adapted to receive a conduit therethrough, said heat reactive blocking means including at least two layers of intumescent material with a layer of fabric therebetween.

8. A fire collar according to claim 7, wherein said mounting includes a housing having a passage therethrough and openings at opposite ends with said heat reactive blocking means being housed within said housing and being adapted to at least partially form a sleeve about a conduit passing through said passage.

9. A fire collar adapted to be set into a concrete barrier during formation of the barrier, including:
a housing;
heat reactive blocking means in said housing including at least two layers of intumescent material with a layer of fabric between at least two of said at least two layers of intumescent material and defining a passage adapted to receive a conduit therethrough, said housing being adapted to protect said heat reactive blocking means and maintain said passage during formation of a concrete barrier about said housing.

10. A heat reactive material including one or more layers of fabric substantially encased in an intumescent material.

11. A heat reactive material including an intumescent material having one or more layers of fabric therein engaged with said intumescent material.

12. A heat reactive material including an intumescent material having a fabric therein adapted in use to enhance the ability of the cohesive forces in the intumescent material to generally hold the intumescent material in a predetermined space.
